(19) United States
(12) Patent Application Publication
(10) Pub. No.: US 2013/0274910 A1
(43) Pub. Date: Oct. 17, 2013

(54) METHOD FOR CONTROLLING A PRODUCTION FACILITY BY HIGH-RESOLUTION LOCATION TRACKING OF WORKPIECES

(71) Applicants: Willi Weingarten, Moers (DE); Siegfried Herrmann, Siegen (DE)

(72) Inventors: Willi Weingarten, Moers (DE); Siegfried Herrmann, Siegen (DE)

(73) Assignee: Salzgitter Mannesmann Prazisrohr GmbH Kissinger Weg, Hamm (DE)

(21) Appl. No.: 13/565,255

(22) Filed: Aug. 2, 2012

(30) Foreign Application Priority Data
Aug. 3, 2011 (DE) 10 2011 109 511.3

(51) Int. Cl. G05B 19/418

(52) U.S. Cl. CPC G05B 19/4183
USPC 700/115

(57) ABSTRACT

A method for controlling a production facility using high-resolution location tracking of workpieces includes determining the current position of the start of the workpiece and the end of the workpiece being currently transported through the facility using position sensors and interposed displacement sensors arranged at different positions of the production facility, and measuring a length of the workpiece from a combination of at least two position sensors and at least one interposed displacement sensor or of at least two displacement sensors and at least one interposed position sensor. The physically determined positions at the various position sensors are compared with a nominal position of the workpiece calculated from the obtained measurement data, and a message is displayed and/or a test is terminated and/or the production facility is stopped when the physically determined positions exceed deviation limit values.

### CROSS-REFERENCES TO RELATED APPLICATIONS

This application claims the priority of German Patent Application, Serial No. 10 2011 109 511.3, filed Aug. 3, 2011, pursuant to 35 U.S.C. 119(a)-(d), the content of which is incorporated herein by reference in its entirety as if fully set forth herein.

### BACKGROUND OF THE INVENTION

The present invention relates to a method for controlling a production facility using high-resolution location tracking of workpieces, particularly of pipes made of steel.

The following discussion of related art is provided to assist the reader in understanding the advantages of the invention, and is not to be construed as an admission that this related art is prior art to this invention.

Although examples of problems associated with controlling a testing facility for pipes by location tracking through a precise determination of position and length are addressed hereinafter, this problem basically applies to all facilities, such as manufacturing or testing facilities where accurate information about the respective position of the facility or specimen must be obtained during the ongoing production flow. These may also apply in addition to pipes, for example, rods, plates or any other products to be transported through the facility.

In many highly automated production areas, pre-finished and finished products must be transported simultaneously very quickly and with high precision. Thus, for example in production of precision pipes, the pipes are successively tested in a testing facility with different testing systems for integrity and compliance with customer specifications. High testing velocities up to several meters per second, continuous testing and the need for error-free localization of a precision of millimeters precise require a real-time control system with reaction times of a few 100 us.

To control the testing system, i.e. for the proper transport of pipes through the system, it is imperative to always have precise knowledge about the current position of the starts of the pipe and the ends of the pipe of all pipes in the facility. Only in this way can the insertion and removal of the test equipment in addition to an exact determination of the pipe length be measured. This can be achieved by using “location tracking components” such as position sensors (e.g. light barriers) and displacement sensors (e.g. pulse generators or contactless operating path tracking sensors), which are arranged at various points in the production flow of the test path and detect the start and/or end of the pipe. The location of the pipe transported through the testing system is precisely monitored by a corresponding number of position sensors, wherein the distance traveled by the pipe through the facility is determined with the pulse generators.

Pulse generators that are permanently attached at the pipe conveyor belts or drives or dynamically activatable during transport of the pipes measure the movement of the conveyor belt or the pipe located thereon. The permanently attached pulse generators are here connected to the drive of a drive roller, wherein the drive roller can be set down with friction contact on the conveyor belt or pipe and lifted off again from the conveyor belt or pipe. In particular, dynamically placed pulse generators are set down on or lifted off the pipe by the facility control system during the transport of the object and advantageously provide a slip-free local coordinate measurement.

Both the lengths of the pipes actually transported through the facility and their current location can be determined from the obtained data and used to control the testing facility.

In practice, however, it has proven difficult to monitor complex inter-dependent sensor systems during ongoing operation and then precisely control the testing system.

The activation/opening accuracy of rolling elements depends, however, on the accuracy with which the pipe is tracked. Errors in the pipe position can damage the pipes, the transport devices and/or the testing mechanisms. Furthermore, activation/deactivation of the various test functions is triggered by the current pipe position.

It is desirable to inspect the entire pipe length as completely as possible; however, technical limitations exist so that the resulting untested and therefore non-standard pipe ends usually have to be cut off and scrapped. However, with good location accuracy, the portion of untested pipe ends can be limited to a few millimeters of the pipe length, thereby significantly increasing the yield and the efficiency.

It has been customary up to now to determine the length of the pipe currently transported through the facility at a single location of the testing system and to set the determined value to be constant for the transport through the testing system. The length measurement is usually carried out already at the inlet region of the testing system so as to obtain as early as possible information about the length of the pipe to be tested.

The measurement is made, for example, with two light barriers and an interposed pulse generator. When the start of the pipe passes a light barrier, the pulse generator is simultaneously activated, counting the pulses along the path. The measurement ends when the pipe end passes through the other light barrier. The length of the pipe can then be calculated using the following formula:

Length of the pipe=number of pulses along the path×resolution of the pulse generator+distance between the light barriers.

The length can basically also be measured using two pulse generators and a single interposed light barrier, although switching the pulse generator during the ongoing measurement is not uncritical and should therefore be used only in exceptional situations.

Position tracking and length measurement of the workpiece are subject to several error sources acting on the location tracking components which distort the measurement results and hence lead to misinterpretations about the facility status and the pipes passing through and their positions in the facility.

The following features should be mentioned, for example:
The resolution factor of the pulse generator, which results in a measurement error of 15 mm with a measurement distance of e.g. 15 m and a resolution factor error of, for example, 0.1%,
Slippage of the drive rolls of the pulse generator on the conveyor belt or pipe surface,
Wear of the drive rolls, i.e. changes in diameter and thus rotation speed,
Incorrect, time-delayed placement/lift-off of the pulse generators,
Switching time of the light barriers, causing the measurement to have a path error of 1 mm, for example, at a pipe velocity of 3 m/s and a switching time variation of 333 μs,
Defective light barriers or incorrectly calibrated light barriers,
Orientation of the light barriers produce different measurements as a function front pipe diameter, for example, when the light barrier is not exactly aligned perpendicular to the pipe axis,
Switching delays of the switching elements, for example when using optocouplers.

Because the pipe length can vary from pipe to pipe and thus also the number and arrangement of the active sensors for pipe tracking, it is very difficult with conventional methods to identify incorrect positioning or the responsible sensors (e.g. light barriers, encoders) in the test path responsible therefor. The detection of positioning errors and/or the search for the responsible sensor during ongoing operation is therefore quite difficult and time-consuming. After the sensor has been identified, the faulty sensors need to be manually recalibrated which is quite cumbersome.

It would therefore be desirable and advantageous to obviate prior art shortcomings and to provide an improved method for controlling a production facility for workpieces, in particular of a testing system for pipes, wherein with the more accurate location tracking, the facility can be more accurately controlled and the quality can be improved by reducing the unexamined end regions of the pipes to be tested. In addition, incorrect information due to faulty location information caused by defective or incorrectly calibrated sensors during testing of the workpieces (pipes) can be reduced.

It would also be desirable to provide an early warning system for identifying faulty or incorrectly calibrated sensors and for implementing self-monitoring with self-calibration of the sensor components.

### SUMMARY OF THE INVENTION

According to one aspect of the present invention, a method for controlling a production facility with high resolution location tracking of workpieces, in particular of pipes, includes the steps of physically determining a current position of a start of a workpiece and an end of the workpiece end currently transported through the facility using position sensors and interposed displacement sensors arranged at different positions of the production facility during ongoing production, measuring at a predetermined location of the production facility a length of the workpiece by using a combination of at least two position sensors and at least one interposed displacement sensor or by using at least two displacement sensors and at least one interposed position sensor, transmitting determined values relating to the current position and the length of the workpiece to an evaluation unit, comparing the physically determined positions at the position sensors with a nominal position of the workpiece calculated from the determined values, using values from the evaluation unit for controlling the production facility, and outputting a message on a display or terminating a test or stopping the production facility when the physically determined positions exceed deviation limit values.

According to an advantageous feature of the present invention, the length of the workpiece is measured in the inlet area of the test path with, for example, two position sensors and one displacement sensor, wherefrom the nominal length of the workpiece (pipe) is calculated. For example, light barriers can be used as position sensors and pulse generators as displacement sensors. The measured values of all other possible combinations are then compared and evaluated for length measurement based on this calculated length value.

In contrast to the known prior art, where only the (actual) positions determined physically, for example, with light barriers and pulse generators are used to control the facility, an adjustment is made to a mathematically determined position in the process of the invention, wherein a much more precise location tracking of the workpiece (pipe) passing through the production facility and thus a more accurate control of the facility becomes possible by taking into account a limit value and redundancy. In addition, incorrect information caused by faulty or incorrectly calibrated sensors is significantly reduced.

The precise location tracking also enables more precise testing along the length of the workpiece, so that untested ends of workpieces and thus yield losses caused by cutting off untested workpiece ends are significantly reduced.

According to an advantageous feature of the present invention, the deviations for a large number of workpieces that have already been transported through the production facility are determined to recognize long-term trends. Advantageously, these data are visualized on a display screen and suitably stored for later evaluations.

To further improve the location tracking of the workpieces (pipes), the length is measured redundantly with light barriers and distance transducers located at several places of the production facility, wherein the measured values are compared with deviation limit values and the deviation are assigned to respective the light barriers and distance transducers participating in the measurement. Advantageously, inferences can then be made with respect to the malfunctioning sensors and corrective measures initiated. During the transport of the workpieces through the production facility, all possible combinations of length measurements for the current workpiece length obtained from two position sensors and a single interposed pulse generator or from two displacement sensors and a single interposed position sensor are used so as to produce redundant results. The deviations of these redundant results are processed into a quality criterion and simultaneously compared with an internally determined expected position. When deviation limit values are exceeded, a message is displayed and/or the test is terminated and/or the facility is stopped.

According to another advantageous feature of the present invention, a control variable is determined when the limit values associated with the position sensors and/or the displacement sensors are exceeded and used for recalibrating the corresponding sensors. Advantageously, the sensors are recalibrated automatically, thereby preventing downtimes and significantly increasing the yield and the productivity.

According to another embodiment of the invention, the measurement values and the deviations from limit values are supplied to a visual display unit, so that deviations and trends can be easily spotted visually.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a shows a high-resolution location tracking for a short pipe according to the present invention;

FIG. 1b shows a high-resolution location tracking for a long pipe according to the present invention;

FIG. 2 shows the measured position deviations determined from the measurement values; and

FIG. 3 shows measured length deviations determined from the measurement values.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

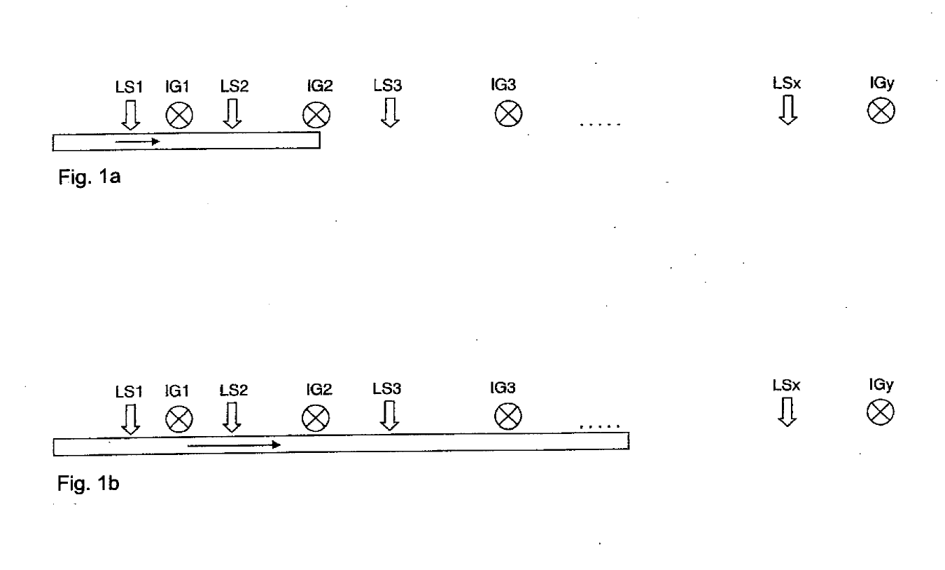

Turning now to the drawing, and in particular to FIG. 1, there is shown a pipe testing system, which is controlled by the high-resolution location tracking according to the invention, is illustrated in the schematic diagrams in FIG. 1a for a short pipe and in FIG. 1b for a long pipe.

It is imperative for an unproblematic transport of the pipes through the facility that the current position of the pipe ends of all pipes in the facility is precisely known at all times. Only then can the test devices be accurately inserted/removed, in addition to an exact measurement of the pipe length.

Attaining this objective requires the use of so-called “location tracking components.” The pipe transported through the facility is monitored with a suitable number of light barriers. The light barriers are labeled “LS . . . ” and the pulse generator is labeled “IG . . . ”.

The passage of the pipe through the facility is tracked with the pulse generators IG1 to IGy. The pulse generators may be either fixedly connected with belts or drives or may be coupled to the pipe for activation. When the pulse generators are fixedly connected, the driver speed is not necessarily identical to the pipe speed due to slippage. Because the drive rolls as a force-transmitting drive wear out over time, the diameter of the drive roller and thus the conversion factor for determining the position also change over time. Activatable pulse generators offer high measurement accuracy, since they couple directly to the pipe surface. However, high measurement accuracy requires that the pulse generators are activated only after they have been safely set down and move with the pipe without slippage. Setting the pulse generators and lifting them off again is controlled by signals above the light barriers.

The length measurement according to FIGS. 1a and 1b is advantageous performed using two light barriers and a single interposed pulse generator. The start of the pipe travels first past the first light barrier LS1. When the start of the pipe reaches the position of the pulse generator IG1, the pulse generator IG1 is turned on and activated. When the start of the pipe crosses the next light barrier LS2, the length measurement is started and the pulses from the pulse generator are counted continuously until the pipe end clears the first light barrier LS1. The determined pipe length is then obtained from the counted pulses and the distance between the two light barriers. A similar measurement is possible with any pair of light barriers that includes a pulse generator and whose spacing is smaller than the actual pipe length.

The measurement accuracy of this measurement depends largely on three factors:

Accuracy of the pulse generator,

Distance between the two light barriers (optical),

Switching times of the two light barriers.

The switching times of the light barriers are calibrated internally, wherein the accuracy of the pulse generator or the correction of the length to be adjusted (equal to the deviation between the measured physical distance between the two light barriers and the optically active distance) represents a system of equations with two independent unknowns. A calibration therefore requires a series of measurements with pipes of different lengths travelling at a constant speed. The length correction and the correction factor for the pulse generator can then be determined from this measurement series. In particular, the correction factor is an extremely sensitive control variable which depends on the length of the pipe to be tested.

The sensitivity of the correction factor is illustrated by comparing a short pipe having a length of e.g. 5 m shown in FIG. 1a and a long pipe having a length of e.g. 15 m shown in FIG. 1b. The distance between the light barriers LS1 and LS2 is e.g. 2 m.

The pulse generator IG1 must “count” 13 m pipe between the activation of the second light barrier LS2 and the release of the first light barrier must LS1. In order to achieve a resolution of, for example, 1 mm, the accuracy of the pulse generator must be better than 1/13000, or approximately 0.07 parts per thousand. This demonstrates the necessary care in the determination of the correction factor and the frequent recalibration of correction factors. Changes in the 3^{rd} or 4^{th} decimal point of the correction factor already have major impacts on the measurement accuracy.

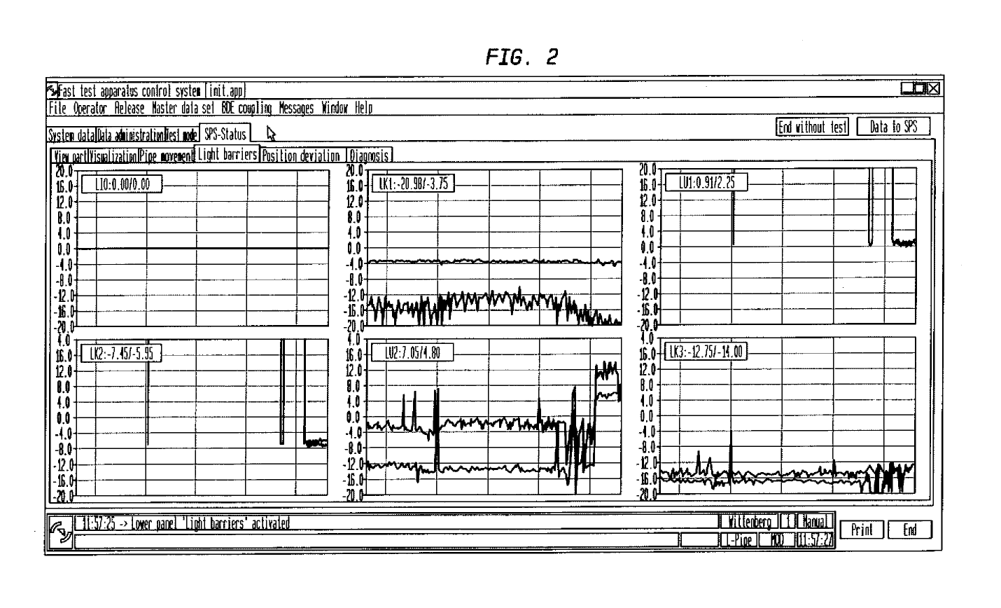

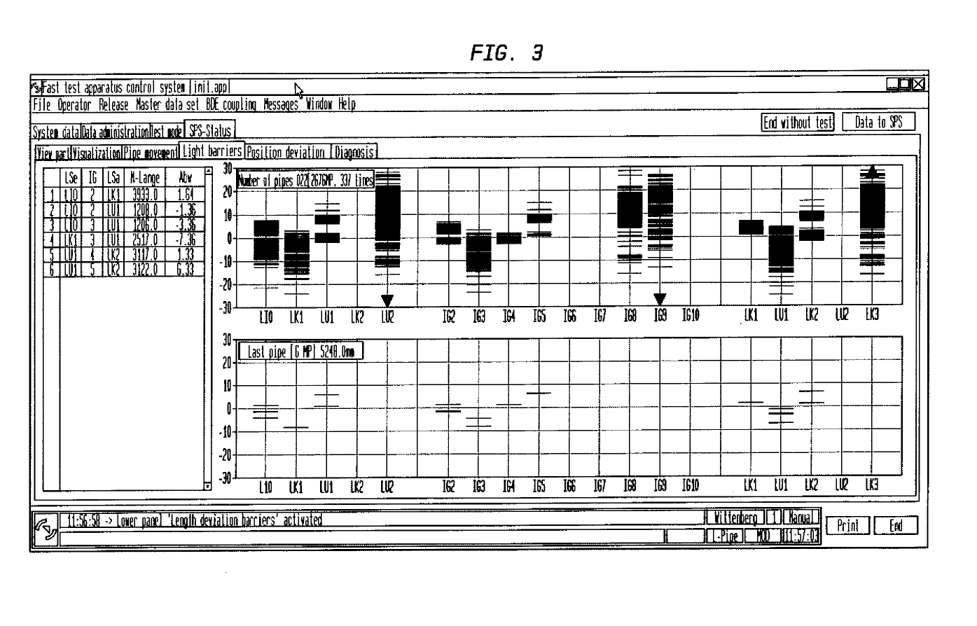

FIG. 2 shows the measured position deviations determined from the measurement values for the light barriers and FIG. 3 shows the length deviations.

FIG. 2 shows in six diagrams the accuracy of location tracking of the pipes transported through the facility. Each of the six diagrams describes the detected deviations in the accuracy at the location of a light barrier, which are in this example labeled with LI0, LK1, LU1, LK2, LU2 and LK3.

Since the mechanical positions of these light barriers are known to the system and since the “release” or “activation” of these light barriers during transport of the pipe are also detected, the known position of the sensor can be compared with the assumed position of the transported pipe at every change in the state of one of the light barriers. The difference between the assumed position and the position of the light barrier is the error of the pipe tracking system. This value can be determined for each light barrier for both the start of the incoming pipe and for the end of the exiting pipe. Both values are entered in the corresponding diagram.

The first sensor (here LI0) is used as reference point for the location tracking; the deviations are therefore always 0. For the other light barriers, values are transferred into the diagram for each pipe when a gap is recognized between the two consecutive pipes. When a light barrier is passed in “joint-to-joint” operation (see the diagram of the light barriers LU1 and LK2, respectively, in FIG. 2), no deviations are detected and therefore also not visualized.

For the last pipe transported through the facility, the deviations are each shown additionally in numerical form in the upper left corner of the diagram. Shown are by scrolling, for example, the last 200 pipes. Additional logging of the deviations in log files allows additional, more extensive analysis of the transport deviations by customers.

FIG. 3 shows in two diagrams the accuracy of the light barriers and pulse generators using the redundant capabilities of pipe length measurement. Measuring a length requires either a combination of two light barriers and one interposed pulse generator or a combination of two pulse generators and one interposed light barrier.

The first variant is always preferred since switching of the pulse generator in the ongoing measurement is not uncritical. The pipe enters the facility, traverses the first light barrier, reaches the pulse generator, which is then activated, and then reaches the second light barrier. Activation of this light barrier starts the count of the pulse generator pulses. These pulses are counted, until the pipe end releases the first light barrier again. The measured pipe length is then determined from the counted pulses and the distance between the two light barriers.

A smaller or greater number of combinations of two light barriers and one pulse generator allowing a length measurement can be employed, depending on the pipe length during transport of the pipes through the facility.

Using a 15 m pipe as an example, more than 40 possibilities for pipe length measurements are obtained commensurate with the number of light barriers L . . . (6) and pulse generators IG . . . (11) (FIG. 3).

FIG. 3 shows the combination of light barrier-pulse generator-light barrier, the measurement distance measured by the pulse generator and the resulting measurement deviation. To capture only meaningful values, only those combinations were considered for which the measurement distance of the pulse generators is greater than 1000 mm. The two diagrams of this mask show on the y-axis the determined deviations of all individual measurements of the pipe length calculated when the pipe entered the inlet.

The sensors involved in a measurement are indicated on the x-axis. These are, from left to right, the light barriers LI0-LU2 terminating the measurement, the possible pulse generators IG2-IG10 and the light barriers LK1-LK3 starting the measurement. Three components are involved in each measurement. The determined deviation is in each case entered into the corresponding field of each of the three involved sensors in form of a bar. If the deviation is outside the tolerance range, then this is represented by an arrow at the upper or lower edge.

The lower curve is deleted after each passage of a pipe, i.e. it includes the values of the last pipe. The upper curve is not automatically deleted, i.e. the results obtained from the pipes are added here, but may be deleted by the operator at any time.

The interpretation of the illustrated deviations allows an easy and fast detection of defective and/or incorrectly calibrated sensors. Incorrect conversion factors for the pulse generators can also be detected as well as incorrect positions of the light barriers.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for controlling a production facility with high resolution location tracking of workpieces, in particular of pipes, comprising the steps of:
physically determining a current position of a start of a workpiece and an end of the workpiece end currently transported through the facility using position sensors and interposed displacement sensors arranged at different positions of the production facility during ongoing production,
measuring at a predetermined location of the production facility a length of the workpiece by using a combination of at least two position sensors and at least one interposed displacement sensor or by using at least two displacement sensors and at least one interposed position sensor,
transmitting determined values relating to the current position and the length of the workpiece to an evaluation unit,
comparing the physically determined positions at the position sensors with a nominal position of the workpiece calculated from the determined values,
using values from the evaluation unit for controlling the production facility, and
outputting a message on a display or terminating a test or stopping the production facility when the physically determined positions exceed deviation limit values.

2. The method of claim 1, further comprising the steps of:
recording and evaluating deviations for a plurality of workpieces that have already been transported through the production facility, and
determining long-term trends from the evaluated deviations.

3. The method of claim 1, further comprising the steps of:
measuring the length of the workpiece redundantly with the position sensors and displacement sensors arranged at several locations of the production facility,
comparing determined measurement values with deviation limit values,
associating the deviations between the measurement values and the deviation limit values with the particular sensors participating in the measurement, and
determining malfunctioning sensors based on the deviations.

4. The method of claim 3, further comprising the steps of:
determining a control variable when the deviations associated with the particular sensors exceed a predetermined value, and
recalibrating the particular sensors using the control variable.

5. The method of claim 4, wherein the particular sensors are recalibrated automatically.

6. The method of claim 3 wherein the determined measurement values and the deviations are transmitted to a visual display unit.

7. The method of claim 1, wherein the position sensor comprises a light barrier and the displacement sensor comprises a pulse generator.
